(19) United States
(12) Patent Application Publication
(10) Pub. No.: US 2005/0141531 A1
(43) Pub. Date: Jun. 30, 2005

(54) Communication relay method and relay device

(75) Inventors: Masafumi Kinoshita, Sagamihara (JP); Daisuke Yokota, Yokohama (JP); Yasuhiro Takahashi, Kawasaki (JP); Mitsuru Ikezawa, Sagamihara (JP); Fumio Noda, Kodaira (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/022,066

(22) Filed: Dec. 21, 2004

(30) Foreign Application Priority Data
Dec. 25, 2003 (JP) 2003-428622

(51) Int. Cl. H04L 12/56; H04L 12/28

(52) U.S. Cl. 370/401

(57) ABSTRACT

A method for handling data packets in a relay device that is provided in a network comprises receiving a data packet including a packet header and packet data from a first client, the data packet identifying a second client to which the data packet is to be directed, the packet header including a first source address identifying the first client; associating the first source address to a second source address, the second source address obtained from one of a plurality of addresses assigned to the relay device; and transmitting the data packet to the second client after writing the second source address to the packet header of the data packet.

### CROSS-REFERENCES TO RELATED APPLICATIONS

This application claims priority to Japanese Patent Application No. 2003-428622, filed on Dec. 25, 2003.

### BACKGROUND OF THE INVENTION

The present invention relates to a communication relay method and relay device provided in a network system.

IP phone, video conferencing, and other similar services for transmitting/receiving voice, video, and other media data over an IP network in real time are beginning to become widespread. In the use of IP phones, a device called a call control device controls the start and end of a phone call. Upon receipt of a call start request from a calling client device, the call control device transfers the request to the destination or called client device. If the destination client device is ready for voice communication, the source or calling client device is informed of such readiness. The IP phone voice data is directly exchanged between the client two devices, e.g., using TCP/IP protocol. For a service involving real-time communication, it is necessary to exercise communication control as described above for the purpose of identifying a packet for transmitting/receiving media data related to the service and establishing real-time communication.

Further, there is a threat that the voice data used in an IP phone call between the client devices might be improperly accessed by a third party on the IP network who intercepts the IP packets. Therefore, there is a need for preventing such improper interception of IP packets.

### BRIEF SUMMARY OF THE INVENTION

When a gateway device described in JP Laid-open No. 2002-232461 encrypts an IP packet's TCP header and media data in such a manner that the encrypted information can be decrypted only by the client devices engaged in a communication, the port number of an IP packet received by the gateway device, is encrypted. Therefore, voice data cannot be recognized and it is difficult to exercise communication control. In other words, it is difficult to prevent voice, video, and other media data from being delayed and improve the communication quality.

Further, there is a similar problem with a method for recognizing media data by making use of information contained in a TCP header and packet data instead of a port number.

The embodiments of the present invention provide a cryptographic communication relay method and relay device for identifying media data even when it is encrypted, and exercising communication control in accordance with the result of identification.

In one embodiment, a relay device is installed between a client device and IP network. The relay device incorporates a function for relaying a call handled between client devices, a function for checking a media data type contained in a call setup request to determine whether an IP packet includes voice data that is exchanged between the client devices, a function for relaying the voice data/IP packet that is exchanged between the client devices, and a function for writing, when relaying the above voice data, identification data into an IP packet's IP header to indicate that voice data is contained in an IP packet.

A traffic control device which controls the communication receives the IP packet having an IP header into which the identification data is written by the relay device. The traffic control device according to the present invention has a function for recognizing the above identification data, which is contained in the IP header of the above IP packet. This function determines that voice data is contained in the above IP packet. Consequently, the traffic control device can give the above IP packet priority over other IP packets improving IP phone communication quality. The present embodiment provides a cryptographic communication relay method that uses the above means to exercise communication control.

The present embodiment may be used for voice data, video data, and other media data that required real-time communication. Further, the present invention can also be applied to communications based on digitized multimedia data, such as file exchanges, chats, and games.

The present embodiment provides communication quality control even when cryptographic communications are maintained so that the packet data contained in IP packets are encrypted.

One embodiment relates to a relay device for relaying a data communication that is established between a first client device and a second client device that are coupled to each other via a network, wherein an address having identification data for communication control is preassigned. The relay device comprises a receiver to receive a data communication request from said first client device; a converting component to convert a source address for transmitting a packet for said data communication with said second client device to an address having said identification data; and a transmitting component to transmit to the network said packet for which said source address has been rewritten.

Another embodiment relates to a communication system in which a communication control device exercises communication quality and/or access controls over a data communication that is established between a first client device and a second client device via a relay device. The relay device has a predefined address having identification data for communication control. The relay device comprises means for receiving a data communication request from said first client device; means for converting a source address for transmitting a packet for said data communication with said second client device to an address having said identification data; and means for transmitting to said communication control device said packet for which said source address has been rewritten. The communication control device comprises means for communication quality control, which is specified by an address having said identification data, over a data transmission from said first client device to said second client device and a data transmission from said second client device to said first client device.

Another embodiment relates to a relay device provide between a first client and a second client in a network. The relay device comprises a receiving component to receive a data packet including a packet header and packet data from the first client, the data packet identifying the second client to which the data packet is to be directed, the packet header including a first source address identifying the first client; a component to associate the first source address to a second source address, the second source address obtained from one of a plurality of addresses assigned to the relay device; and a transmitting component to transmit the data packet to the second client after writing the second source address to the packet header of the data packet.

Yet another embodiment relates to a method for handling data packets in a relay device that is provided in a network. The method comprises receiving a data packet including a packet header and packet data from a first client, the data packet identifying a second client to which the data packet is to be directed, the packet header including a first source address identifying the first client; associating the first source address to a second source address, the second source address obtained from one of a plurality of addresses assigned to the relay device; and transmitting the data packet to the second client after writing the second source address to the packet header of the data packet.

### BRIEF DESCRIPTION OF THE DRAWINGS

FIG. 1 shows a typical configuration of a network system that uses a relay device 1 according to one embodiment of the present invention.

FIG. 2 shows the configuration of the relay device 1.

FIG. 3 shows one embodiment of an address management table 103 that is incorporated in the relay device 1.

FIG. 4 shows a typical structure of an IP packet.

FIG. 5 shows IP phone message flows that illustrate how call control is exercised among a call control device 2a and client devices 4.

FIG. 6 is a flowchart illustrating one embodiment of a process that is performed by the relay device 1.

### DETAILED DESCRIPTION OF THE INVENTION

Embodiments of the present invention will now be described with reference to the accompanying drawings. The following description assumes that voice data is handled as media data.

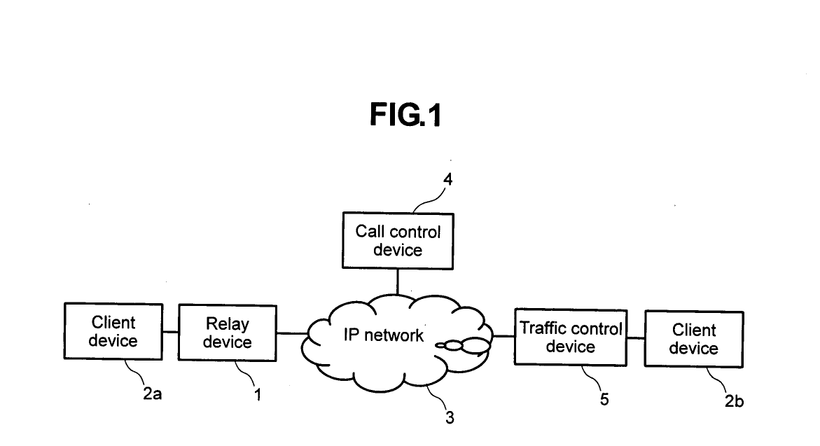

FIG. 1 schematically illustrates the configuration of a network system to which a relay device 1 according to a first embodiment of the present invention is applied.

A client device 2a is connected to an IP network 3 via the relay device 1. Another client device 2b is connected to the IP network 3 via a traffic control device 5. The traffic control devices control the flow of packets. The control devices may be a communication control device that controls the flow of packets, or provides access control (e.g., firewall functions), or both.

The client devices 2a, 2b are PCs having a voice communication function or IP phones. They also have a function for conveying specific communication data (e.g., voice data) after encrypting it in such a manner that only the client device at the receiving end can decrypt it. It is assumed that the IP network 3 is either the Internet or an intranet. For illustrative convenience, the client device 2a is referred to as a source device, and the client device 2b as a destination device at various places herein.

In the configuration shown in FIG. 1, a call initiation process, in which a voice communication request is issued from client device 2a to client device 2b using the call control device. A response is also provided via the control device 4. Similarly, a termination request is made and its response is made using the call control device 4. Once a call is initiated, communications are directly exchanged between the client devices 2a, 2b.

For IP phone communication, various items of information are written into the packets for the call initiation process and call disconnection process to indicate a request type (which indicates whether a voice communication request and its response or a termination request and its response are to be processed), a source address (which is a caller's IP address), a callee identifier (which identifies a callee), a media data type which indicates the type of media data targeted for communication), a call control device's IP address, and information indicating whether voice communication is achievable.

The addresses of terminals for call-controlled voice communication are hereinafter referred to as the caller address and callee address. As viewed from the relay device, IP packets include source and destination addresses. Accordingly, an address may be a source/destination address or caller/callee address depending on the application.

Although FIG. 1 shows only one call control device 4, the network according to the present embodiment involves a plurality of call control devices 4. Therefore, the present invention can also be applied to a case where the call process is relayed from one call control device to another and then forwarded to a client device.

When client device 2b initiates a call in a configuration shown in FIG. 1, client device 2b is connected to the IP network 3 via the relay device 1, and client device 2a is connected to the IP network 3 via the traffic control device 5. Alternatively, client device 2a may be connected to the IP network 3 via the relay device 1 and traffic control device 5 with client device 2b connected to the IP network 3 via the relay device 1 and traffic control device 5.

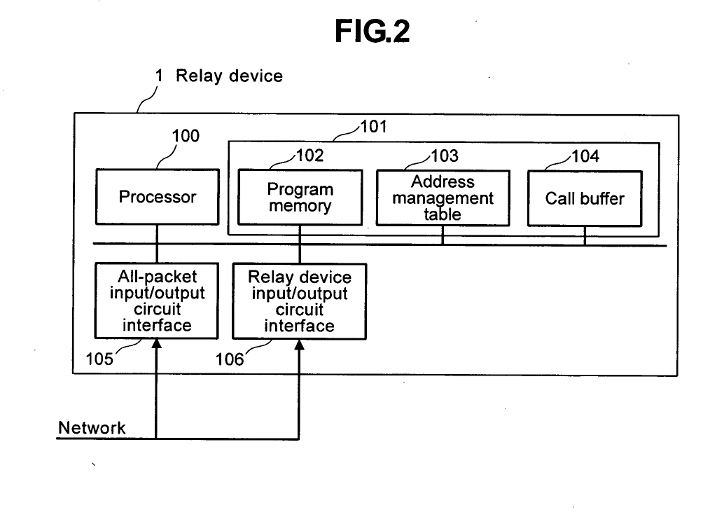

FIG. 2 shows the hardware configuration of an information processing device that implements the relay device 1. The information processing device implementing the relay device 1 comprises a processor 100, a storage device 101, a packet input/output circuit interface 105 for transmitting IP packets to and receiving them from the network, an input/output circuit interface 106 for transmitting IP packets bound to the relay device 1 to and receiving them from the network, and internal communication wiring such as a bus for interconnecting the above elements.

The storage device 101 comprises a semiconductor memory device or an external storage device such as a hard disk, and includes a program memory 102, an address management table 103, and a call buffer 104. The program memory 102 records various control programs, which cause the information processing device to operate as the relay device 1. When execution is performed by the processor 100, various functions described below are implemented in the information processing device. The call buffer 104 stores recovered packetized data, which is received by the relay device 1. The relay device 1 may be provided with an input device (not shown) and a display device (not shown), which permit a system administrator to enter data. The table 103 may be stored in a separate memory on storage component from the program memory 102 or within the same component.

The hardware configuration of the traffic control device 5, which is not shown, is similar to that of the relay device 1. The device 5 includes a processor, a storage device, one or more communication interfaces, and programs that are stored in the storage device. Some functions of the traffic control device 5 may be embodied in electrical circuits.

The control programs of the relay device 1 and traffic control device 5 may be stored beforehand in the storage device 101 or may be introduced into the storage device 101 via a removable storage medium or communication medium (that is, a network or a carrier wave propagating through a network), which is not shown but is available to the information processing device.

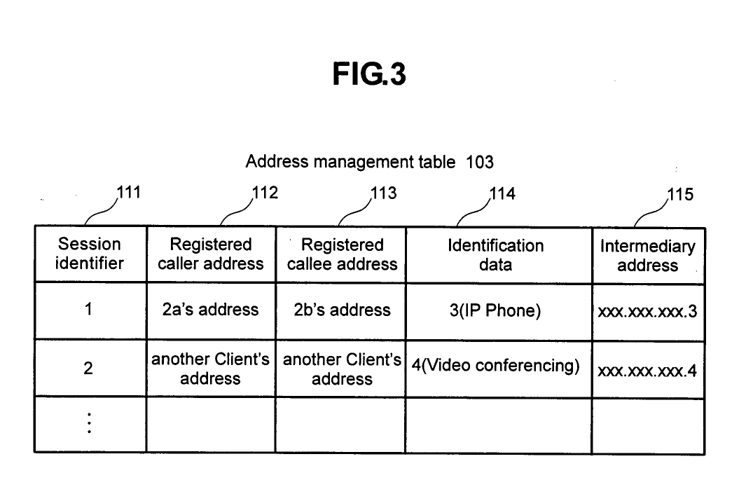

FIG. 3 shows a typical structure of the address management table 103. The entries in the address management table 103 are a session identifier 111, a registered caller address 112, a registered callee address 113, identification data 114, and an intermediary address 115. A pair of the caller and callee addresses comprise a session address. In the present embodiment, the table 103 includes a plurality of session addresses.

An identifier for differentiating each session is shown in the session identifier 111. The source address of a call is registered in the registered caller address 112 when the relay device 1 receives a voice communication request from client device 2a. The IP address of client device 2b, which is stored in a response to the voice communication request, is registered in the registered callee address 113.

A media data type, obtained from the voice communication request, is stored in the identification data 114. The identification data 114 may also store an identifier for identifying the registered caller address 112 or registered callee address 113 may be stored in the identification data 114. In such a case, the above access control device can be used to provide access control over each caller and each callee.

In the present embodiment, a plurality of sets of identification data 114 are predefined, and a plurality of IP addresses are assigned to the relay device 1. The relay device checks the IP addresses assigned to it when identification data 114 is generated and registered. One of the IP addresses is selected and stored in the intermediary address 115 with the identification data. When an IP packet transmission from the registered caller address 112 to the registered callee address 113 is received after registration of all the entries in the address management table 103, the relay device 1 changes the source address of the IP packet to an intermediary address 115. The traffic control device 5 exercises traffic control in accordance with the intermediary address 115. Subsequently, the IP packet's source IP address, which is changed to permit the relay device 1 to exercise traffic control, is indicated as the intermediary address 115. Meanwhile, one IP address containing no identification data and serving purposes other than the relay device 1's traffic control is indicated as a relay device address.

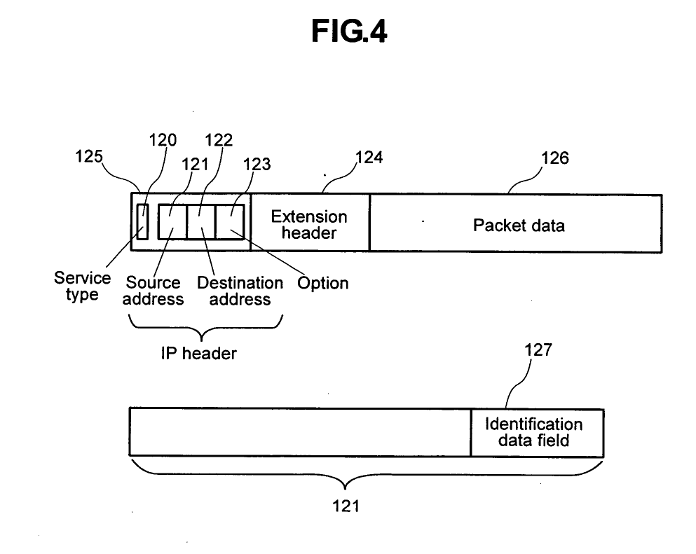

FIG. 4 shows an example of an encrypted IP packet.

The IP packet comprises an IP header 125 and packet data 126. An extension header 124 may occasionally be included in the IP packet. The packet data 126 is encrypted to prevent the IP packet from being accessed without authorization. The encrypted packet data makes it difficult to decrypt the packet data by parties other than the source and destination.

The IP header 125 includes a service type 120, a source address 121, a destination address 122, and an option 123. The type of a delivery service that the IP packet requests a router or the like to provide is stored as the service type 120. The IP address of a device that transmitted the IP packet is stored as the source address 121. The IP address of a device that is to receive the IP packet is stored as the destination address 122. The option 123 is not usually used. However, it can store information about IP packet delivery by a router or the like.

The identification data 114 can be contained in the IP address by, for instance, by defining part of the bit array of a value stored at the source address 121 as an identification data field 127 and storing the identification data 114 in that field. In conventional technique, IP address has only one type of meaning, which is to provide routing information identification. However, the IP address according to the present embodiment makes it possible to identify the type of media data by using the identification data 114.

The identification data field 127 can also store an identifier that identifies the registered caller address 112 and/or registered callee address 113. Accordingly, an IP address can provide various information in the present embodiment.

If, for instance, an access control device is added between the traffic control device 5 and client device 2b, the traffic control device 5 can check the identification data field 127 to determine the type of media data, and the access control device can check the identification data field 127 to determine the identifier for identifying the registered caller address 112 and exercise access control.

It is also possible to write segments of identification data into the IP address and one or more of the service type 120, option 123, and extension header 124. If, for example, the identification data 114 is divided and respectively written into the identification data field 127 and service type 120, the number of intermediary addresses 115 possessed by the relay device 1 can be decreased.

The above IP header structure is based on Internet Protocol Version 4 (IPv4). However, Internet Protocol Version 6 (IPv6) provides a different IP header structure. The IPv6 IP header contains the source address 121 and destination address 122, but does not contain the service type 120 or option 123. Instead, the IPv6 IP header includes a traffic class, which is synonymous with the service type 120, and a flow label, which is an area where the IP packet stores request information concerning router delivery. As a result, IPv6 makes it possible to write identification data into the traffic class and flow label in addition to the IP address and extension header 124.

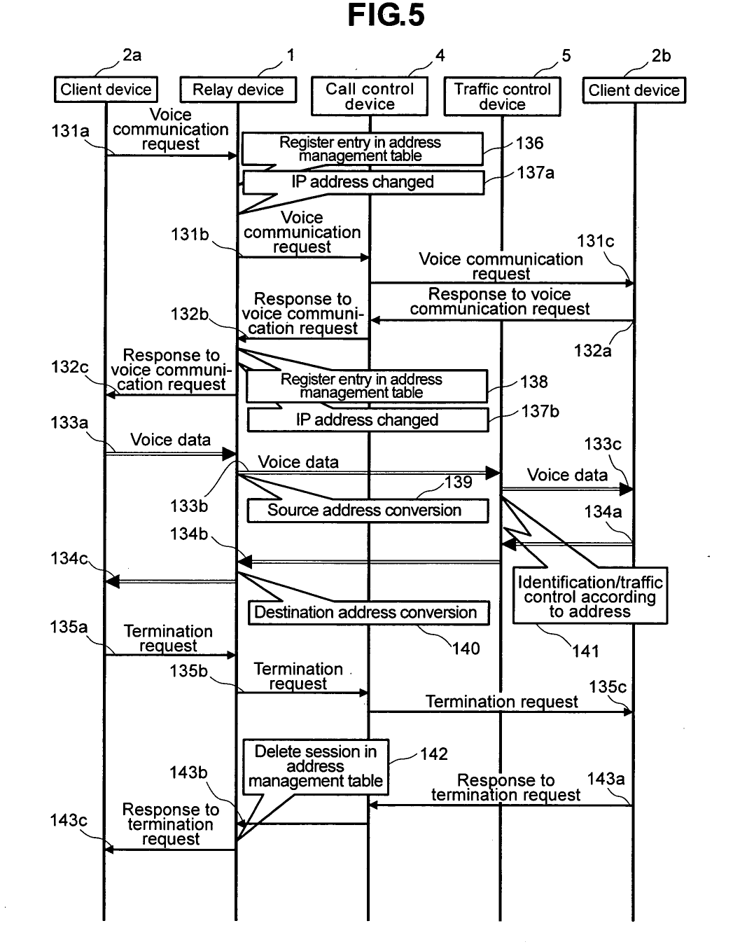

FIG. 5 shows the IP phone message flows of client device 2a and client device 2b. Two flows are indicated in FIG. 5. One flow depicts a call initiation/call disconnection process that is performed among client device 2a, relay device 1, call control device 4, and client device 2b. The other flow depicts a voice data flow among client device 2a, relay device 1, traffic control device 5, and client device 2b.

First of all, client device 2a transmits a voice communication request to a relay device address (voice communication request 131a). The relay device 1 generates a unique identifier and stores it in a session identifier 111 in the address management table 103, registers a registered caller address 112, identification data 114, and intermediary address 115 in accordance with the source address 121 and media data type of the received voice communication request 131a (step 136), changes the source address 121 of the voice communication request 131a to an intermediary address 115 (step 137a), and transfers the resultant address to the call control device 4, which is predetermined within the network system configuration (voice communication request 131b). The call control device 4 transfers the received address to client device 2b, which is designated by a callee identifier that is written in the received voice communication request 131b (voice communication request 131c).

Client device 2b receives the voice communication request 131c and transmits a response to the call control device 4 for the purpose of indicating, for instance, whether voice communication can be established. The call control device 4 sends its transmission to the relay device address, which is the source of transmission (response to voice communication request 132b).

The relay device 1 registers the written callee address, which is the IP address of client device 2b, to the registered callee address 113 in the address management table 103 (step 138), changes the destination address 122 to the registered caller address 112 in accordance with the address management table 103 (step 137b), and transmits the resultant address to client device 2a (response 132c). Client device 2a receives the response 132c and acquires the callee address. Client device 2a is now ready to initiate voice communication.

Client device 2a transmits an IP packet, which stores voice data, to client device 2b (voice data 133a). The above IP packet is encrypted by client device 2a. To receive all IP packets from client device 2a, the relay device 1 receives the above IP packet and then changes the source address 121 of the above IP packet to an intermediary address 115 by using an address management table entry whose registered callee address 112 corresponds to the destination address 122 of the IP packet (step 139). The relay device 1 transmits the above IP packet to the traffic control device 5 (IP packet including voice data 133b).

For the traffic control device 5, the intermediary address 115, which is the IP address targeted for traffic control and possessed by the relay device 1, is set beforehand. The intermediary address may be set by the system administrator or by allowing the traffic control device 5 to communicate with the relay device 1. Therefore, traffic control is exercised when the received IP packet's destination address 122 or the source address 121 corresponds to the above IP address that has been set beforehand. For example, traffic control is exercised because the received IP packet can be recognized as a voice data IP packet for an IP phone (step 141). When the call is to be eventually terminated (by disconnecting the call), either client device 2a or client device 2b issues a termination request 135a. Upon receipt of a response 143b to the call termination request 143a from either client device, the relay device 1 deletes the session identifier 111, registered caller address 112, registered callee address 113, identification data 114, and intermediary address 115, which are registered in the address management table 103 (step 142), and transmits a response to the termination request to the call transfer destination (response 143c).

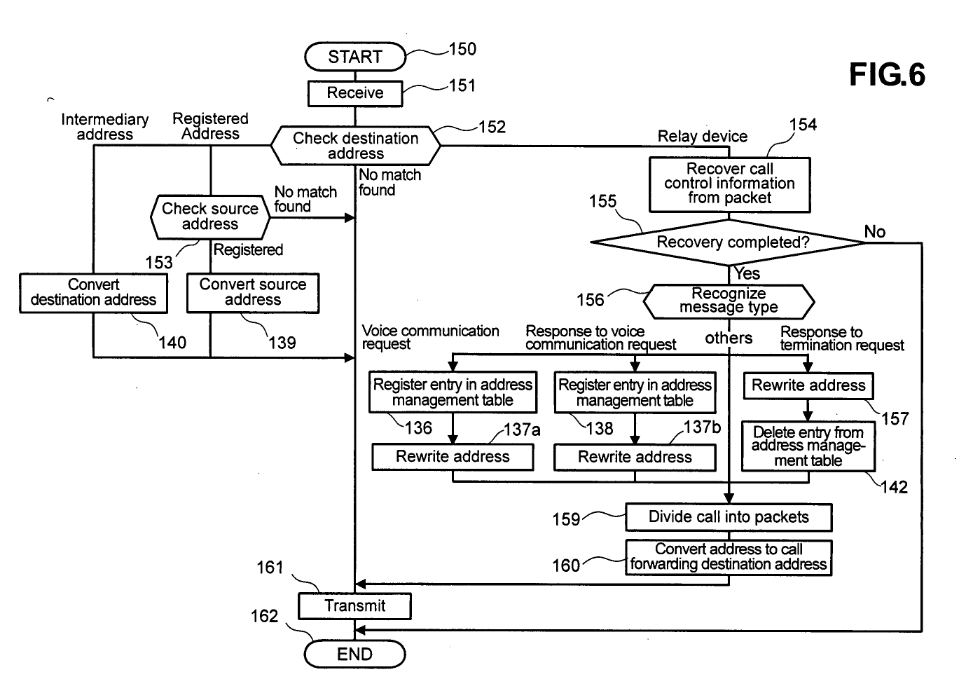

FIG. 6 is a flowchart illustrating a series of processing steps that are performed for each IP packet. The operation of the relay device 1, which is implemented by the processor 100, will now be described with reference to FIG. 6.

The relay device 1 receives an IP packet (step 151), and compares the IP packet's destination address 122 against the IP address of the relay device 1, or the relay device address, or the registered callee address 113 in the address management table 103 to check whether the IP packet's destination address 122 corresponds to the IP address of the relay device 1, the relay device address, or the registered callee address 113 in the address management table 103 (step 152). If the destination address differs from the IP address of the relay device 1, the relay device address, and the registered callee address 113 in the address management table 103, the program flow proceeds to step 161.

If the IP packet's destination address 122 is an intermediary address 115, the relay device 1 converts the IP packet's destination address 122 to a corresponding registered caller address 112 (step 140). If the IP packet's destination address 122 is a registered callee address 113, step 153 is performed to check whether the IP packet's source address corresponds to a registered callee address 112. If the IP packet's source address corresponds to a registered callee address 112, step 139 is performed to convert the IP packet's source address 121 to an intermediary address 115. If, on the other hand, the IP packet's source address does not correspond to a registered callee address 112, the program flow proceeds to step 161. If the destination address 122 is the IP address of the relay device 1, the program flow proceeds to step 154 because the above IP packet is a call IP packet.

The relay device 1 gathers the received call process packets and reconstructs the call control information (step 154). Step 155 is performed to judge whether the reconstruction is completed. If the reconstruction is not completed, the program flow proceeds to step 162. In step 162, the relay device 1 terminates a series of processing steps that have been performed since the reception of one IP packet.

When the reconstruction is completed, step 156 is performed to check whether the written request type represents a voice communication request, a response to a voice communication request, a termination request, or none of these. If the call request type is a voice communication request, step 136 is performed to register a unique identifier as the session identifier 111, register the call's media data type as the identification data 114, assign the IP address that corresponds to the media data type and is possessed by the relay device 1, and register the above IP address as the intermediary address 115.

The destination address 122 for the IP packet of the above call and the above written callee address are converted to a registered caller address 112 (step 137a), and transmitted to the above callee address (step 161). If the above call's request type is a response to a voice communication request, the call's callee address is registered as a registered caller address in the address management table 103 (step 138). Step 137b is then performed to convert the above call's IP packet destination address 122 and the callee address written in the call control information to a corresponding registered caller address 112 in the address management table 103, and then the program flow proceeds to step 161.

If the above call's request type is a response to a termination request, step 157 is performed to convert the callee address to a registered caller address 121. Next, step 142 is performed to delete the session identifier 111, registered caller address 112, registered callee address 113, identification data 114, and intermediary address 115, which are registered in the address management table 103, and then the program flow proceeds to step 159. The above call is divided into appropriate IP packets (step 159) and transmitted to the IP network 3 (step 161).

The present embodiment enables the traffic control device 5 to identify media data even when it is encrypted, and exercise communication control in accordance with the identification result.

A second embodiment of the invention provides similar advantages, as the first embodiment as the former enables the relay device 1 to relay voice data between the client devices without receiving all the packet transmissions from client device 2a unlike the first embodiment. Some differences between the first and second embodiments will now be described with reference to FIGS. 1, 5, and 6.

The configuration shown in FIG. 1 is changed so that a switch is mounted in the position of the relay device 1, and that the relay device 1 is connected to the switch only, and further that the switch connects the relay device 1 to the IP network 3 and a client 2. The switch recognizes the destination address 122 of a received IP packet. If the destination address corresponds to the intermediary address 115, the IP packet is transferred to the relay device 1. If, on the other hand, the destination address agrees with client device 2a, the IP packet is transferred to client device 2a. If the destination address agrees with neither of the above two, the IP packet is transferred to the IP network 3.

In FIG. 5, the differences are steps 137b, 139, and 140 and calls 132c, 133a, and 134b. In step 137b, the relay device 1 not only converts the callee address to a registered caller address 112 but also converts the caller address to an intermediary address 115.

Client device 2a receives a call 132c, and transmits voice data to the intermediary address 115 stored at the callee address for the call (133a). Since the destination address 122 for the received IP packet 133a is an intermediary address 115, the relay device 1 converts the source address 121 to an intermediary address 115 in step 140 if the source address 121 for the IP packet is a registered caller address 112. Further, the relay device 1 converts the destination address 122 for the IP packet to a registered callee address 113. As regards the IP packet 133b, the source address 121 is an intermediary address 115 and the destination address 122 is the IP address of client device 2b. Therefore, the IP packet is the same as the packet for 133b in the first embodiment, and the traffic control device 5 can exercise traffic control. Further, if the source IP address for the received IP packet is a registered callee address 113, the relay device 1 converts the source IP address to an intermediary address 115 in step 140.

In FIG. 6, the differences are steps 137 and 140. Step 140 is as described above. In step 137, the relay device 1 converts the destination address 122 for the IP packet and the callee address to a registered caller address 112, and converts the callee address to an intermediary address 115.

Since a switch is provided in the second embodiment, the relay device 1 does not have to receive and identify all the packet transmissions from client device 2a. However, the second embodiment still provides the same advantages as the first embodiment.

A third embodiment of the present invention differs from the first embodiment in that the former gives a preferred band to voice data for cryptographic communication without inserting identification data 114 into the source address 121 for a voice data packet received by the relay device 1. The method for giving such a preferred band will be described below.

Some of the differences between the first and third embodiments will now be described with reference to FIG. 5. In FIG. 5, steps 137a, 137b, and 140 are not required for the third embodiment. In step 139, the identification data 114 is inserted into the service type 120, option 123, or extension header 124 in the packet received by the relay device 1. Step 141 is performed to exercise traffic control after recognizing the identification data 114 that is inserted into the service type 120, option 123, and extension header 124 for the IP header in the IP packet received by the traffic control device 5. When IPv6 is used, the identification data is inserted into the traffic class, flow label, or extension header 124.

In the third embodiment, the relay device 1 inserts the identification data 114 into the service type 120, option 123, and extension header 124 for the voice data IP packet. Therefore, the third embodiment provides the same advantages as the first embodiment without changing the source address 121 for the IP packet.

Unlike the foregoing embodiments, a firewall or other similar access control device may alternatively be used instead of the traffic control device 5. The use of such an alternative configuration enables the relay device 1 to insert user identification data, which identifies the user of client device 2a, into the source IP address for IP packet, and exercise access control while identifying the user from the source IP address of an IP packet received by the access control device.

Although the foregoing embodiments handle voice data as the media data, the present invention can also be applied to the other types of media data.

The present invention has been described using specific embodiments. These embodiments may be changed or modified without departing from the scope of the invention. The scope of the invention should be interpreted using the appended claims.

1. A relay device for relaying a data communication that is established between a first client device and a second client device that are coupled to each other via a network:
wherein an address having identification data for communication control is preassigned, said relay device comprising;
a receiver to receive a data communication request from said first client device;
a converting component to convert a source address for transmitting a packet for said data communication with said second client device to an address having said identification data; and
a transmitting component to transmit to the network said packet for which said source address has been rewritten.

2. The relay device according to claim 1, further comprising:
means for assigning an address having said assigned identification data to said communication upon receipt of said data communication request from the first client device, handling said assigned address as a source address, and requesting the establishment of said data communication; and
means for converting, upon receipt of a response to said request for the establishment of said data communication, in which said assigned address is used as a destination address, the destination address being an address associated with said first client device.

3. The relay device according to claim 1, further comprising:
means for converting, upon receipt of a packet bound to a destination address having said identification data, the destination address being associated with an address of the second client; and
means for transmitting the packet for which said destination address has been converted.

4. The relay device according to claim 1, wherein relay device maintains a plurality of addresses having said identification data, the plurality of addresses being predefined; and
wherein said address conversion means converts the source address of said packet to one of said predefined addresses in accordance with a data type contained in said data communication request.

5. The relay device according to claim 1, further comprising:
means for inserting part of said identification data into one or more of a service type, option, or extension header of said packet,
wherein the remaining portion of said identification data is assigned to said address.

6. A communication system in which a communication control device exercises communication quality and/or access controls over a data communication that is established between a first client device and a second client device via a relay device, wherein said relay device has a predefined address having identification data for communication control, and comprises:
means for receiving a data communication request from said first client device;
means for converting a source address for transmitting a packet for said data communication with said second client device to an address having said identification data; and
means for transmitting to said communication control device said packet for which said source address has been rewritten; and
wherein said communication control device comprises:
means for communication quality control, which is specified by an address having said identification data, over a data transmission from said first client device to said second client device and a data transmission from said second client device to said first client device.

7. The communication system according to claim 6,
wherein said relay device comprises:
means for assigning, upon receipt of said data communication request, an address having said assigned identification data to said data communication, handling said assigned address as a source address, and requesting the establishment of said data communication; and
means for converting, upon receipt of a response to said request in which said assigned address is used as a destination address, the destination address being associated with an address of said first client device..

8. A relay device provide between a first client and a second client in a network, the relay device comprising:
a receiving component to receive a data packet including a packet header and packet data from the first client, the data packet identifying the second client to which the data packet is to be directed, the packet header including a first source address identifying the first client;
a component to associate the first source address to a second source address, the second source address obtained from one of a plurality of addresses assigned to the relay device; and
a transmitting component to transmit the data packet to the second client after writing the second source address to the packet header of the data packet.
wherein the data packet includes voice information.

9. The relay device of claim 8, further comprising:
means for receiving a communication request from the first client to initiate communication with the second client, the communication request including the first source address identifying the first client, a destination address identifying the second client, and a communication type indicating the type of data communication requested by the first client; and
means for generating a session record using the communication request, the session record including a caller address, a callee address, and identification data, the caller address corresponding to the first source address, the callee address corresponding to the destination address, and the identification data corresponding to the communication type.

10. The relay device 8, further comprising:
means for generating an intermediary address including the caller address and the identification data; and
means for adding the intermediary address as part of the generated session record.

11. A method for handling data packets in a relay device that is provided in a network, the method comprising:
receiving a data packet including a packet header and packet data from a first client, the data packet identifying a second client to which the data packet is to be directed, the packet header including a first source address identifying the first client;
associating the first source address to a second source address, the second source address obtained from one of a plurality of addresses assigned to the relay device; and
transmitting the data packet to the second client after writing the second source address to the packet header of the data packet.

12. The method of claim 11, further comprising:
receiving a communication request from the first client to initiate communication with the second client, the communication request including the first source address identifying the first client, a destination address identifying the second client, and a communication type indicating the type of data communication requested by the first client; and
generating a session record using the communication request, the session record including a caller address, a callee address, and identification data, the caller address corresponding to the first source address, the callee address corresponding to the destination address, and the identification data corresponding to the communication type.

13. The method of claim 12, further comprising:
generating an intermediary address including the caller address and the identification data; and
adding the intermediary address as part of the generated session record.

14. The method of claim 13, further comprising:
storing the generated session record as an entry in an address management table maintained by the relay device, the address management table including a plurality of session records, each session record being assigned with one of the assigned addresses of the relay devices; and
selecting a session record corresponding to the data packet received by the relay device from the plurality of session records stored in the address management table,
wherein the second source address for the data packet corresponds to an intermediary address of the selected session record.

15. The method of claim 11, wherein the address assigned to the relay device are session addresses, wherein the second source address is generated using one of the session addresses, the second source address including identification data indicating a communication type of the data packet, the data packet being a first data packet.

16. The method of claim 15, wherein the communication type indicated by the identification data is voice data communication, video data communication or an instant messaging communication, wherein a communication control device provided between the second client and relay device uses the identification data included in the second source address to give priority to the first data packet over a second data packet relating to a different communication type than that of the first data packet.

17. The method of claim 11, wherein the packet data of the data packet received by the relay device has been encrypted to prevent unauthorized access to the packet data.

18. The method of claim 17, further comprising:
receiving a communication request from the first client to initiate communication with the second client, the communication request including the first source address identifying the first client, a destination address identifying the second client, and a communication type indicating the type of data communication requested by the first client; and
generating a session record using the communication request, the session record including a caller address, a callee address, identification data, and an intermediary address, the caller address corresponding to the first source address, the callee address corresponding to the destination address, the identification data corresponding to the communication type, the intermediary address including the callee address and the identification data.

19. The method of claim 18, wherein the data packet received by the relay device has been encrypted by the first client to prevent unauthorized access of the packet data, wherein the intermediary address corresponds to the second source address of the data packet, the identification data of the intermediary address being used by a traffic control device to provide priority to the data packet over another data packet, the traffic control device being located between the second client and relay device.

20. The method of claim 18, wherein the communication request is for a real-time communication, the method further comprising:
transmitting a request to a call control device to establish a communication link between the first client and the second client, the request to initiate corresponding to the communication request received at the relay device from the first client,
wherein the data packet received from the first client is transmitted to the second client using the communication link established by the communication control device after the second source address has been provided for the data packet by the relay device.

21. The method of claim 20, wherein the first source address of the data packet is replaced with the second source address, wherein the relay device is provided with a plurality of session addresses, each session address being assigned to a given session initiated according to the communication request.
